(19) United States
(12) Patent Application Publication
(10) Pub. No.: US 2006/0213331 A1
(43) Pub. Date: Sep. 28, 2006

(54) Method for reducing metal oxide and method for producing hydrogen

(76) Inventors: Kiyoshi Otsuka, Saitama (JP); Sakae Takenaka, Tokyo (JP); Kiyozumi Nakamura, Saitama (JP); Kazuyuki Iizuka, Saitama (JP)

Correspondence Address: ANDERSON, KILL & OLICK, P.C., 1251 AVENUE OF THE AMERICAS, NEW YORK,, NY, 10020-1182, US

(21) Appl. No.: 10/556,171

(22) PCT Filed: Feb. 24, 2004
(86) PCT No.: PCT/JP04/02128

§ 371 Date: Nov. 8, 2005

(30) Foreign Application Priority Data
May 9, 2003 (JP) 2003-131180
Sep. 17, 2003 (JP) 2003-324168

(51) Int. Cl. C22B 23/00; C22B 11/02; C22B 15/00; C01B 3/02

(52) U.S. Cl. 75/627; 423/648.1; 75/629; 75/631; 75/632; 75/633; 75/641

(57) ABSTRACT

A method for reducing a metal oxide and a method for manufacturing hydrogen are provided for easily reducing an oxide of a metal that decomposes water to generate hydrogen, using a gas that includes hydrocarbons, such as municipal gas. The method for reducing the metal oxide includes the step of reducing, using a reducing gas that includes hydrocarbons, a medium comprising an oxide of a metal that decomposes water to generate hydrogen, and at least one metal selected from the group consisting of platinum group elements, copper, nickel and cobalt. Furthermore, the method for manufacturing hydrogen includes the above-described reducing step, and a water-decomposing step of reacting water with the medium that is reduced in the reducing step, to generate hydrogen.

### TECHNICAL FIELD

The present invention relates to a method for reducing metal oxides, and to a method for manufacturing hydrogen.

### BACKGROUND ART

Technologies for manufacturing hydrogen in order to provide hydrogen for fuel cells are being actively researched. A technique for manufacturing hydrogen by contacting pure iron with water vapor is known as one of these. Pure iron is oxidized to iron oxide by the production of hydrogen. This iron oxide has conventionally been reduced using hydrogen (for example, see JP 2002-173301 A). However, in terms of practicality, in the case of reducing iron oxide with hydrogen, there is presently no established infrastructure for providing hydrogen, and it is difficult to popularize such a system in the market.

### DISCLOSURE OF THE INVENTION

Thus, there is a desire for the development of a technique for reducing iron oxide using a reducing agent that has a well established infrastructure. As a reducing agent that has an established infrastructure, municipal gas, whose principal component is methane, may be considered, for example. Light fraction hydrocarbons such as bottled propane and butane are reducing agents whose infrastructure is relatively well established. Of course, it is also possible to consider the use of hydrocarbons such as gasoline, kerosene and diesel oil as reducing agents. However, in order to reduce iron oxide using these hydrocarbons, it is generally necessary to use high temperatures greater than 800° C., and high pressure of at least 50 atmospheres. However, for the manufacture of hydrogen for fuel cells, it is required to carry out reduction at lower temperatures. Furthermore, when generating hydrogen by allowing iron that has been reduced by hydrocarbons to contact water vapor, there is the problem of generating a large amount of carbon monoxide and carbon dioxide, caused by deposition of carbon during reduction.

With consideration to the aforementioned problems, it is an object of the present invention to provide a method for reducing a metal oxide and a method for manufacturing hydrogen that can easily reduce the oxide of a metal for decomposing water to generate hydrogen, with a gas that includes hydrocarbons, such as municipal gas.

In order to achieve the aforementioned object, the method for reducing the metal oxide according to the present invention includes the step of reducing, using a reducing gas that includes hydrocarbons, a medium made from an oxide of a metal (hydrogen generating metal) for decomposing water to generate hydrogen, and at least one metal (first additive metal) selected from the group consisting of platinum group elements, copper, nickel and cobalt. Thus, in addition to metal oxides such as iron oxide, by using as the medium a substance to which has been added at least one metal selected from the group consisting of platinum group elements, copper, nickel and cobalt, the platinum group elements, copper, nickel or cobalt serves as a catalyst, whereby it is possible to easily reduce the metal using a reducing gas that includes hydrocarbons such as methane. It should be noted that the platinum group elements refer to six elements, namely rhodium, palladium, iridium, ruthenium, platinum and osmium.

As for the metal for decomposing water to generate hydrogen, it is preferable that it is at least one metal selected from the group consisting of iron, indium, tin, magnesium, gallium, germanium and cerium. The metals have a higher hydrogen generating efficiency than other metals that react with water to generate hydrogen, and they have superior durability to repeated oxidation reduction. Of these, iron is particularly preferable because it can generate a large amount of hydrogen per unit weight of metal.

The aforementioned medium may also include at least one metal (second additive metal) selected from the group consisting of neodymium, aluminum, chromium, gallium, yttrium, zirconium, molybdenum, titanium, vanadium, magnesium and scandium. By further adding such a metal, because it is possible to prevent sintering of the medium due to repeated oxidation and reduction, it is possible to increase the reduction efficiency of the metal oxide and it is also possible to further increase the hydrogen generating efficiency.

The exhaust gas generated in the reduction process may be re-used as the reducing gas. The exhaust gas generated in the reduction process contains excess reducing gas that was not used in the reduction. By reducing the metal oxide again with the excess reducing gas, it is possible to effectively re-use the reducing gas. However, the H₂O, CO and CO₂ generated in the reduction is scavenged, and only pure reducing gas is re-used.

Furthermore, the exhaust gas generated in the aforementioned reduction process may also be used as fuel for heating the medium. The exhaust gas generated in the reduction process contains excess hydrocarbons, such as methane, that were not used in the reduction. Here, by using the exhaust gas as fuel for means for heating the medium, such as heaters that use gas burners or in catalytic combustion, it is possible to effectively re-use the hydrocarbons contained in the exhaust gas.

As a separate aspect, the present invention provides a method for generating hydrogen that includes the reducing step, and a water-decomposing step of generating hydrogen by reacting water with the medium that is reduced in the reducing step. Since the metal oxide is reduced in the reducing step, it can decompose water again to generate hydrogen.

For the medium, it is preferable to use at least two separate media, wherein hydrogen can be continuously manufactured by using one medium for generating hydrogen in the water-decomposing step while using the other medium for reducing in the reducing step. Thus, since it is possible to manufacture hydrogen continuously, it is possible to reliably supply hydrogen to devices that use hydrogen as a fuel, such as fuel cells.

For the method for manufacturing hydrogen according to the present invention, it is preferable to further include a process of medium washing which supplys oxygen to the medium to burn off carbon that is deposited on the medium. Carbon may be deposited on the medium by repeating the reduction step and the water-decomposing step. In this case, by providing oxygen to the medium to burn off the deposited carbon, it is possible to remove the carbon and clean the medium. By removing the carbon in this way, it is possible to suppress generation of carbon monoxide and carbon dioxide in the water-decomposing step.

Thus, with the present invention, it is possible to provide a method for reducing a metal oxide and a method for manufacturing hydrogen that can easily reduce an oxide of a metal that decomposes water to generate hydrogen, using a gas that includes hydrocarbons, such as municipal gas.

### BRIEF DESCRIPTION OF THE DRAWINGS

FIG. 1 is a schematic view showing an appropriate hydrogen manufacturing apparatus that embodies a method for reducing a metal oxide and a method for manufacturing hydrogen, according to the present invention.

FIG. 2 is a schematic view showing a reactor for iron oxide, where (a) shows the case of a reduction reaction, and where (b) shows the case of a water decomposing reaction.

FIG. 3 is a graph showing the change in the oxygen removal rate with respect to elapsed reaction time.

FIG. 4 is a graph showing the change in the oxygen removal rate with respect to elapsed reaction time.

FIG. 5 is a graph showing the change in the oxygen removal rate with respect to elapsed reaction time.

FIG. 6 is a graph showing the change in the oxygen removal rate with respect to elapsed reaction time.

FIG. 7 is a graph showing the amount of hydrogen generated by the iron oxides.

FIG. 8 is a graph showing the amount of CO and CO₂ generated by the iron oxides.

FIG. 9 schematically shows another reactor for iron oxide.

FIG. 10 is a graph showing the rate of CO, CO₂ and H₂ generation when the iron oxides are reduced by methane.

FIG. 11 is a graph showing the rate of H₂, CO and CO₂ generation when the iron oxides decompose the water after being reduced.

FIG. 12 is a graph showing the rate of CO, CO₂ and H₂ generation during reduction, after repeating the reduction reaction and water-decomposing reaction seven times.

FIG. 13 is a graph showing the rate of H₂, CO and CO₂ generation during water-decomposing, after repeating the reduction reaction and the water-decomposing reaction seven times.

### BEST MODE FOR CARRYING OUT THE INVENTION

The embodiments of the present invention are described below with reference to the attached drawings.

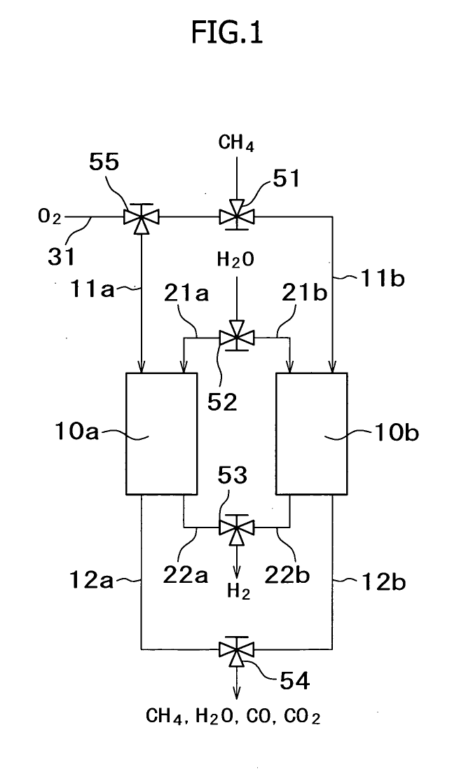

FIG. 1 is a diagram that schematically shows an appropriate hydrogen manufacturing apparatus embodying a method for reducing metal oxides and a method for manufacturing hydrogen, according to the present invention. As shown in FIG. 1, the hydrogen manufacturing apparatus is provided with a reaction tube 10. The reaction tube 10 is provided with a reducing gas introduction line 11 for introducing a reducing gas that includes hydrocarbons, into the reaction tube 10, an exhaust gas discharge line 12 for discharging waste gas produced in the reaction tube 10 by a reduction reaction, a water introduction line 21 for introducing water into the reaction tube 10, and a hydrogen discharge line 22 for discharging the hydrogen produced in the reaction tube 10 by a water-decomposing reaction. It should be noted that the reducing gas introduction line 11 is connected to a source supplying a reducing gas, such as a municipal gas supply source (not shown).

For the reaction tube 10, two reaction tubes, being a first reaction tube 10a and a second reaction tube 10b, are provided in parallel. A three-way valve 51 is provided on the reducing gas introduction line 11, which branches into a first reducing gas introduction line 11a for introducing reducing gas into the first reaction tube 10a, and a second reducing gas introduction line 11b for introducing reducing gas into the second reaction tube 10b. Similarly, the water introduction line 21, the hydrogen discharge line 22 and the exhaust gas discharge line 12 are each provided with a three-way valve 52, 53, and 54, where they each branches into a first water introduction line 21a and a second water introduction line 21a, a first hydrogen discharge line 22a and a second hydrogen discharge line 22b, and a first exhaust gas discharge line 12a and a second exhaust gas discharge line 12b. Furthermore, the hydrogen manufacturing apparatus is provided with an air introduction line 31 for supplying air (oxygen) into the reaction tube 10, and the air introduction line 31 is connected into the first reducing gas introduction line 11a via a three-way valve 55.

The reaction tube 10 is packed with a medium that includes an oxide of a metal (hydrogen generating metal) for generating hydrogen by decomposing water, and at least one metal (first additive metal) selected from the group consisting of platinum group elements, copper (Cu), nickel (Ni) and cobalt (Co). For the hydrogen generating metal, from the point of view of a high hydrogen generating efficiency, and superior durability to repeated oxidation and reduction, it is preferable to use any one of iron (Fe), indium (In), tin (Sn), magnesium (Mg), gallium (Ga), germanium (Ge) and cerium (Ce), and of these, Fe is most preferable. These metal oxides may be a low valence metal oxide such as FeO, or a high valence metal oxide such as Fe₂O₃ or Fe₃O₄.

Furthermore, from the view point of oxidation reduction efficiency, for the first additive metal, even from among rhodium (Rh), palladium (Pd), iridium (Ir), ruthenium (Ru), platinum (Pt) and osmium (Os), which are platinum group elements, Rh, Pd, Ir, Ru and Pt are preferable, and Rh and Pd are particularly preferable. Furthermore, it is also possible to use Cu, Ni and Co, which are cheaper than the platinum group elements and have lower atomic weights, and these have a reduction oxidation efficiency equivalent to that of the platinum group elements. When the total of the metals in the medium is taken to be 100 mol %, the addition ratio of the first additive metal is preferably 0.1 to 30 mol %, and is more preferably 0.1 to 5 mol %. With an addition ratio of less than 0.1 mol %, it is not possible to sufficiently exhibit the effect of reducing the metal oxides by the reducing gas that includes hydrocarbons. On the other hand, it is not preferable that the addition ratio is greater than 30 mol %, because the efficiency of the oxidation-reduction reactions of the metal for decomposing water and generating hydrogen decreases.

From the view point of increasing the efficiency of reducing the metal oxides, and the generation efficiency of hydrogen, it is preferable to further add to the medium at least one metal (second additive metal) selected from the group consisting of neodymium (Nd), aluminum (Al), chromium (Cr), gallium (Ga), yttrium (Y), zirconium (Zr), molybdenum (Mo) titanium (Ti), vanadium (V), magnesium (Mg) and scandium (Sc). Of these, from the point of view of preventing sintering due to repeated oxidation and reduction, Nd, Al, Cr, Ga, Y, Zr and Mo are preferable, and Nd, Al, Ga, Zr and Mo are particularly preferable. When the total metal content in the medium is taken to be 100 mol %, the addition ratio of the second additive metal is preferably 0.1 to 30 mol %, and more preferably 0.1 to 15 mol %. It is not preferable that the addition ratio is less than 0.1 mol %, because the effect of increasing the reduction efficiency of the metal oxide or the generating efficiency of hydrogen cannot be confirmed. On the other hand, it is not preferable that the addition ratio is greater than 30 mol %, because there is a reduction in the efficiency of the oxidation-reduction reactions of the metal for decomposing water to produce hydrogen.

As a method for preparing the medium in which the first additive metal, and if desired, the second additive metal, are dosed into the oxide of the hydrogen generating metal, it is possible to use, for example, a physical mixing method, an impregnation method and a co-precipitation method, wherein preparation is preferably by the co-precipitation method. Furthermore, in order to efficiently advance the reduction reaction and the water decomposing reaction, the form of the medium is preferably selected to be a form that has a high surface area suited to the reaction, such as a powder form, pellet form, cylindrical form, honeycomb structure and non-woven fabric shape.

The reaction tube 10 is provided with heating means (not shown) for heating the reaction tube 10. For the heating means, it is possible to use, for example, a resistance heater, or a positive temperature coefficient thermistor (PTC heater), a heater that uses the heat of oxidation by chemical reaction, a heater based on catalytic combustion, a heater that depends on induction heating, or a gas burner that burns hydrocarbons.

With such a configuration, firstly, in order to perform the reduction process in the first reaction tube 10a, the second line 11b and 12b ports of the three-way valves 51 and 54 of the reducing gas introduction line 11 and the exhaust gas discharge line 12 are closed, while the remaining ports are open, and the three way valves 52 and 53 of the water introduction line 21 and the hydrogen discharge line 22 are closed in all directions. Furthermore, the air inlet line 31 port of the three way valve 55 of the air introduction line 31 is closed, while the remaining ports are open. The reducing gas that includes hydrocarbons is then supplied to the first reaction tube 10a via the first reducing gas introduction line 11a. It should be noted that in the reduction process, it is preferable, from the view point of the reducing efficiency of the metal oxide, that the temperature inside the reaction tube 10 is heated by the heating means to about 300° C. to about 700° C., and it is even more preferable that it is heated to about 350° C. to about 600° C.

Here, examples of suitable hydrocarbons include aliphatic hydrocarbons of C₁ to C₁₀ such as methane, ethane, ethylene, and propane; alicyclic hydrocarbons such as cyclohexane and cyclopentane; and aromatic hydrocarbons such as benzene, toluene and xylene. It is also possible to use hydrocarbons that are solid at room temperature, such as paraffin wax. When using hydrocarbons that are solid or liquid at room temperature, they should be gasified. These hydrocarbons may be used individually, or in a combination of two or more types.

In the first reaction tube 10a, the oxide of the hydrogen generating metal in the medium is reduced by the introduced reducing gas to pure metal or to a low valence metal oxide. For example, when the hydrogen generating metal is Fe, and the reducing gas is CH₄, then the reaction formula is as shown below.
FeOₓ+CH₄→FeO_{x-y}+y₁H₂O+y₂CO+y₃CO₂

Here, in the aforementioned formula, FeOₓ represents iron oxide (the chemical formula FeₙOₘ is represented as FeO_{m/n}), where y=y₁+y₂+2y₃, and x≧y.

Furthermore, the exhaust gas produced by the aforementioned reduction reaction is discharged from the first reaction tube 10a via the first exhaust gas discharge line 12a. It should be noted that because the discharged exhaust gas contains excess hydrocarbons that were not used in the reduction reaction, in addition to water, carbon monoxide and carbon dioxide, it is possible to use this as the fuel for the heating means (not shown) for heating the reaction tube 10, and may also be used again as the reducing gas supplied in the reducing gas supply line 11. Before re-using the exhaust gas, it is preferable to remove impurities such as water, carbon monoxide and carbon dioxide.

After the reduction process in the first reaction tube 10a is complete, next, in order to perform the water-decomposing process in the first reaction tube 10a and to perform the reduction process in the second reaction tube 10b, the first line 11a and 12a ports of the three-way valves 51 and 54 on the reducing gas introduction line 11 and the exhaust gas discharge line 12 are closed, while the remaining ports are open, and the second line 21b and 22b ports of the three-way valves 52 and 53 on the water introduction line 21 and the hydrogen discharge line 22 are closed, while the remaining ports are open. Then, water is supplied into the first reaction tube 10a via the first water introduction line 21a, and the reducing gas that includes hydrocarbons is supplied into the second reaction tube 10b via the second reducing gas introduction line 11b. It should be noted that the water may be supplied as water vapor, or as a gas that includes water vapor. Furthermore, in the water-decomposing process, from the viewpoint of hydrogen generating efficiency, it is preferable that the temperature inside the reaction tube 10 is heated by the heating means to about 200° C. to about 600° C., and more preferably is heated to about 300° C. to about 500° C.

In the first reaction tube 10a, the introduced water is heated to water vapor, and this water vapor is decomposed by the hydrogen generating metal (pure metal) or the low valence metal oxide, which are in the medium that is reduced by the reduction process, to generate hydrogen. The hydrogen generating metal (pure metal) or the low valence metal oxide is converted to a low valence metal oxide or a high valence metal oxide by the water-decomposing reaction. When Fe is used as the hydrogen generating metal, then the reaction formula is as shown below.
FeOₓ₋₁+H₂O→FeOₓ+H₂

The hydrogen produced in the first reaction tube 10 is discharged from the hydrogen manufacturing device via the first hydrogen discharge line 22a, and can be supplied to a hydrogen utilizing device (not shown) such as a fuel cell. On the other hand, the aforementioned reduction reaction proceeds in the second reaction tube 10b, and the oxide of the hydrogen generating metal in the medium is reduced to pure metal or to a low valence metal oxide. The exhaust gas produced in the second reaction tube 10b is discharged from the second exhaust gas discharge line 12b, and as described above, may also be re-used as the fuel for the heating means, or as the reducing gas.

After the water-decomposing process in the first reaction tube 10a and the reduction process in the second reaction tube 10b are complete, in order to perform the reduction process in the first reaction tube 10a and the water-decomposing process in the second reaction tube 10b, the second line 11b and 12b ports of the three-way valves 51 and 54 on the reducing gas introduction line 11 and the exhaust gas discharge line 12 are closed, and the remaining ports are open, and the first line 21a and 22a ports of the three-way valves 52 and 53 on the water introduction line 21 and the hydrogen discharge line 22 are closed, and the remaining ports are opened. Then, the reducing gas is supplied again into the first reaction tube 10a via the first reducing gas introduction line 11a, and water is introduced into the second reaction tube 10b via the second water introduction line 21b.

The water (water vapor) introduced into the second reaction tube 10b is decomposed in the aforementioned water-decomposing reaction to generate hydrogen. The hydrogen that is generated is discharged from the second hydrogen discharge line 22b, and is supplied, in the same manner as described above, to a fuel cell, or the like. During this time, the hydrogen generating metal in the medium that is oxidized to the low valence metal oxide, or to the high valence metal oxide by the water-decomposing process, and then is again reduced to pure metal or to the low valence metal oxide by the aforementioned reduction reaction. Consequently, it is possible, again, to perform the water-decomposing reaction to generate hydrogen. In this way, by using the two reaction tubes 10 in turn to repeatedly perform the reduction process and the water-decomposing process, it is possible to manufacture hydrogen continuously.

Carbon may be deposited on the medium in the reaction tube 10 by repeatedly performing the reduction process and the water-decomposing process. In this case, in order to supply oxygen into the reaction tubes 10 to perform a medium washing process to burn and remove the carbon, the three-way valve 55 on the air introduction line 31 is opened in all directions, the first and the second line 11a and 11b ports of the three-way valve 51 on the reducing gas introduction line 11 are opened, while the remaining port is closed, the three way valves 52 and 53 on the water introduction line 21 and the hydrogen discharge line 22 are closed in all directions, and the three way valve 54 on the exhaust gas discharge line 12 is opened in all directions. The air (oxygen) is then supplied into the reaction tubes 10 via the air introduction line 31 and the reducing gas introduction line 11.

Since the temperature in the reaction tube 10 is sufficiently high due to the reduction process or the water-decomposing process, the carbon that is deposited on the medium may be easily burnt off by supplying air (oxygen) into the reaction tube 10. The exhaust gas produced by the combustion discharges from the reaction tube 10 via the exhaust gas discharge line 12. By removing the carbon from the medium and cleaning the medium in this way, it is possible to suppress production of carbon monoxide and carbon dioxide when generating hydrogen in the water-decomposing process. It should be noted that it is also possible to perform the medium washing process on just one of either the first reaction tube 10a or the second reaction tube 10b. Furthermore, in order to ensure that the generation of hydrogen does not stop (or in order to maintain the continuous generation of hydrogen), it is preferable to perform the medium washing process on one, then the other, reaction tube before the reduction process.

The reduction method and the hydrogen manufacturing method according to the present invention have been described using the embodiment shown in FIG. 1, however, the present invention is not limited to the present embodiment, and modifications, alterations and additions within the range of the technical spirit of the present invention are all included in the present invention. For example, it is possible to have only a single reaction tube 10, and it is also possible to provide three or more reaction tubes 10, wherein the reaction tubes are set to repeat the reduction process and the water-decomposing process at a predetermined time lag, so as to continuously manufacture hydrogen. Furthermore, the two reaction tubes may not necessarily be independent, and it is possible to set two zones within a single reaction tube, and to repeat the reduction process and the water-decomposing process in each zone in turn.

The working examples of the present invention and comparative examples will be described next.

### WORKING EXAMPLE 1

Iron oxide into which Rh has been dosed was prepared by the co-precipitation method (urea method) as shown below. Firstly, 0.019 mol of iron (III) nitrate nonahydrate (Fe(NO₃)₃.9H₂O) (manufactured by Wako Pure Chemical Industries Ltd) and 0.001 mol of a chloride of rhodium (RhCl₃.3H₂O) (manufactured by Wako Pure Chemical Industries Ltd) were added into 1 L of water that had been deaerated with ultrasound for 5 min such that the Rh ion was 5 mol % of all metal ions. 1.0 mol of urea was then added as a precipitating agent and all were dissolved. The mixed solution was heated to 90° C. while agitating, and held at the same temperature for 3 hours. After reacting, the solution was left to settle for 48 hours and was then suction filtered. The obtained precipitate was then dried for 24 hours at 80° C., then for 3 hours at 300° C., and was then burnt in air for 10 hours at 500° C. 54.2 mg of the Rh-dosed iron oxide obtained in this way was weighed out, that is to say, the Rh-dosed iron oxide was weighed out so as to contain 50 mg of Fe₂O₃ (ferric oxide) when the Rh ions were dosed to be 5 mol % of the total metal ions, and the compounds were Fe₂O₃ and Rh₂O₃. This obtained material was used as the sample in the experiment to be described hereinafter.

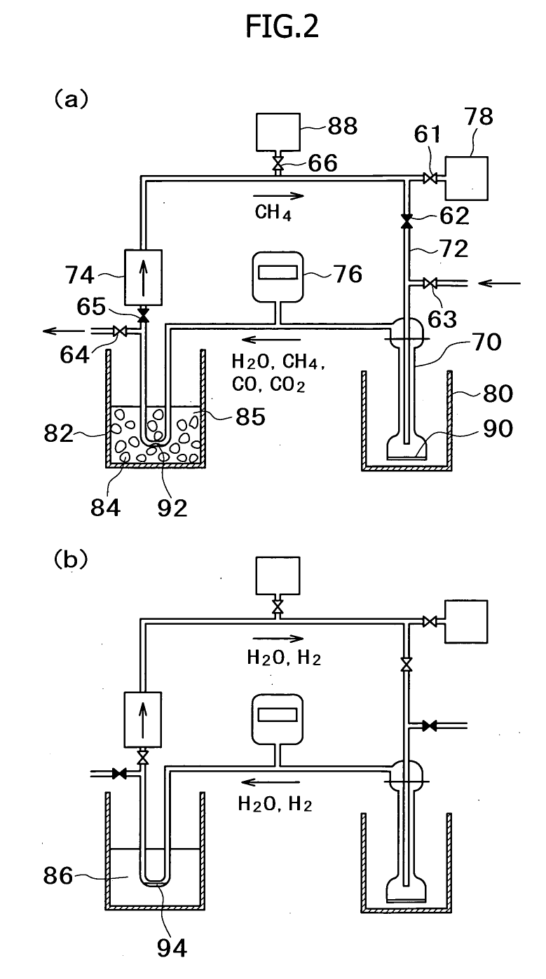

Next, after reduction of the obtained Rh-dosed iron oxide by methane, using the apparatus shown below, an experiment was performed to generate hydrogen by contact with water vapor. FIG. 2 is a view schematically showing an overview of the reaction apparatus used in the present experiment, wherein (a) shows the case of the reduction reaction with methane, and (b) shows the case of the hydrogen generating reaction (water-decomposing reaction).

Firstly, as shown in FIG. 2A, a sample 90 of the obtained Rh-dosed iron oxide was placed into a Pyrex (registered trade mark) glass reaction vessel 70, wherein by closing valves 61, 62, 65 and 66, and opening valves 63 and 64 that are provided on a glass tube 72, the reaction apparatus was made into a fixed-bed flow-type reaction apparatus. Ar, which is an inert gas, was then allowed to flow through the system at room temperature for 10 minutes via the valve 63. After this, the valves 63 and 64 were closed and the valves 62, 65 and 66 were opened, and vacuum discharge was performed for at least 30 minutes with a vacuum pump 88 to achieve a vacuum of less than or equal to 1.3×10⁻⁵ kPa. It should be noted that before performing any of the reduction reaction and the water-decomposing reaction, the vacuum discharge was performed for at least 30 min to achieve a vacuum of less than or equal to 1.3×10⁻⁵ kPa.

Next, in order to perform the reduction reaction, the valves 62, 65 and 66 were closed again, and the valves 63 and 64 were opened. Dry ice 84 and ethanol 85 were packed into a trap device 82 and maintained at a temperature of −76° C. Methane was introduced via the valve 63 such that the initial pressure was 101.3 kPa, and allowed to contact the sample at room temperature. An electric furnace 80 was used to heat the reaction vessel 70 to 600° C. at 30° C./min, and the temperature was maintained at 600° C. for 100 min. The Rh dosed iron oxide was reduced by the methane, producing water, CO and CO₂. Water 92 was condensed in the trap device 80, and was removed. The CO, the CO₂, and the methane that did not contribute to the reduction reaction were discharged via the valve 64. The total flow of the discharged gas was measured by a soap bubble flow meter. The composition of the gas sampled by a gas syringe was analyzed by gas chromatography. The number of moles of oxygen atoms removed from the Rh-dosed iron oxide per minute (oxygen removal rate, units: μmol/min), which was estimated to be the amount that was reduced, was then calculated according to the formula given below, based on these measured results.
Oxygen removal rate=(CO+2CO₂) μmol/min

It should be noted that water was generated during reduction, in addition to CO and CO₂. Although the oxygen that was removed from the iron oxide as water was not calculated, the ratio of the amount of oxygen that is removed as CO and CO₂ to the amount of oxygen that is removed as water is substantially the same in all the reactions, and thus it is possible to analyze qualitatively.

When the reduction reaction with methane was complete, the water 92 that was trapped in the trap device 82 was vaporized and removed with an argon purge. Next, in order to perform the water-decomposing reaction, the valves 63 and 64 were closed and the valves 62 and 65 opened, wherein the reaction apparatus was converted into a closed recycling-type reaction apparatus. 9.39×10⁻⁴ mol of water was introduced into the system. Cold water 86 was then filled into the trap device 82, and kept at a temperature of 14° C. The water 94 that was produced during reduction was vaporized, and the pressure of water vapor in the system at this time was 1.5 kPa. Ar was then introduced as a carrier gas via the valve 63 such that the initial pressure of Ar was 12.5 kPa, and was recycled for 10 min, after which the reaction vessel 70 was heated to 400° C. by the electric furnace 80, and the water vapor was allowed to contact the sample. After maintaining a temperature of 400° C. for 120 min, the reaction vessel 70 was further heated to 500° C. and this was maintained until the reaction that was generating hydrogen was complete. The water was decomposed by the Rh-dosed iron oxide, and the gas that included the thus generated hydrogen was recycled through the system by a gas recycling pump 74. The pressure within the system was then measured by a pressure gauge 76 to measure the amount of gas generated and the amount of gas absorbed, and component analysis of the gas was performed with a gas chromatograph 78 by opening and closing the valve 61. The amount of hydrogen, CO and CO₂ that was generated was thus determined based on these results.

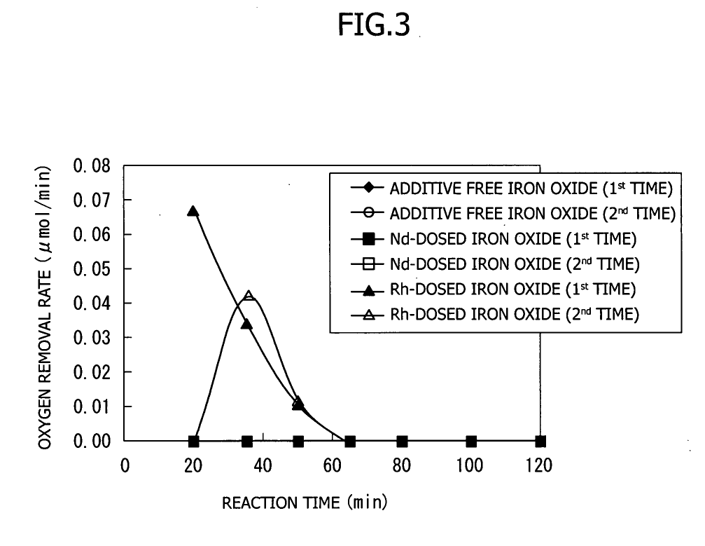

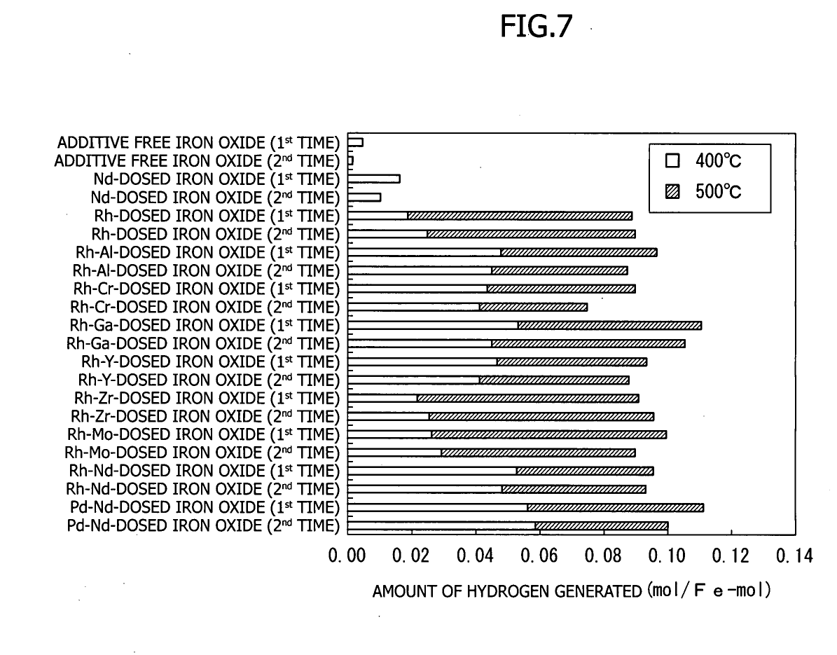

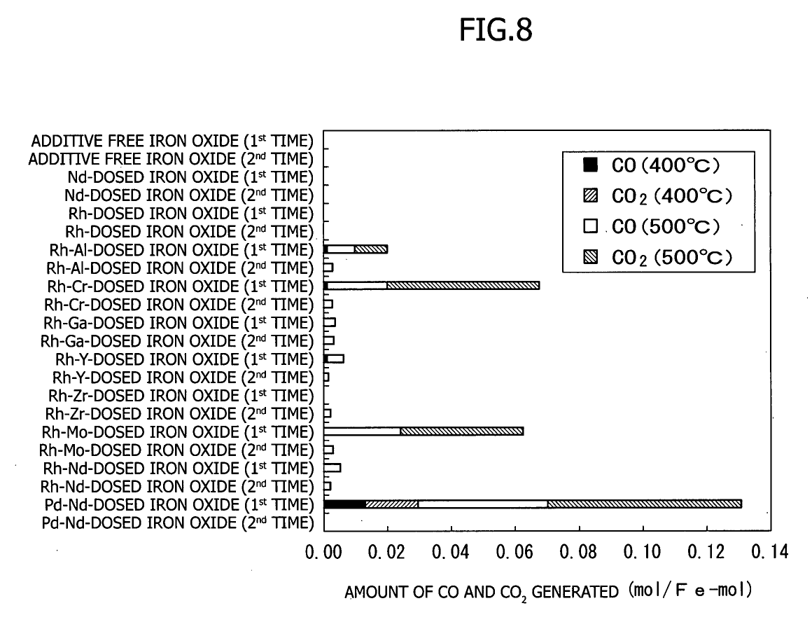

After the water-decomposing reaction was completed, the reduction reaction and the water-decomposing reaction were again performed as per the aforementioned procedure. The reduction reaction and the water-decomposing reaction were performed a total of twice each. The results of the two reduction reactions are shown in FIG. 3, and of the results of the two water-decomposing reactions, the amount of hydrogen that was generated is shown in FIG. 7, and the amount of CO and CO₂ that was generated is shown in FIG. 8.

### COMPARATIVE EXAMPLE 1

Excluding the fact that no chloride of rhodium (RhCl₃.3H₂O) was dosed, an additive-free iron oxide was prepared by the same procedure as in Working Example 1, and the experiment of the reduction reaction and the water-decomposing reaction was performed.

### COMPARATIVE EXAMPLE 2

Except for 0.001 mol of a nitrate of neodymium (Nd(NO₃)₃.6H₂O) (manufactured by Soekawa Chemical Co. Ltd.) being dosed instead of the 0.001 mol of the chloride of rhodium, a Nd-dosed iron oxide was prepared by the same procedure as in Working Example 1, and the experiment of the reduction reaction and the water-decomposing reaction was performed. The results of Comparative Examples 1 and 2 are shown together with the results of Working Example 1 in FIG. 3, FIG. 7 and FIG. 8.

### WORKING EXAMPLE 2

Except for 0.018 mol of iron (III) nitrate nonahydrate (Fe(NO₃)₃.9H₂O) being dosed instead of 0.019 mol, and that 0.001 mol of a nitrate of neodymium (Nd(NO₃)₃.6H₂O) (manufactured by Soekawa Chemical Co. Ltd.) was additionally dosed, such that the Rh ions and the Nd ions were each 5 mol % of the total metal ions, an Rh—Nd-dosed iron oxide was prepared by the same procedure as in Working Example 1, and the experiment of the reduction reaction and the water-decomposing reaction was performed.

### WORKING EXAMPLE 3

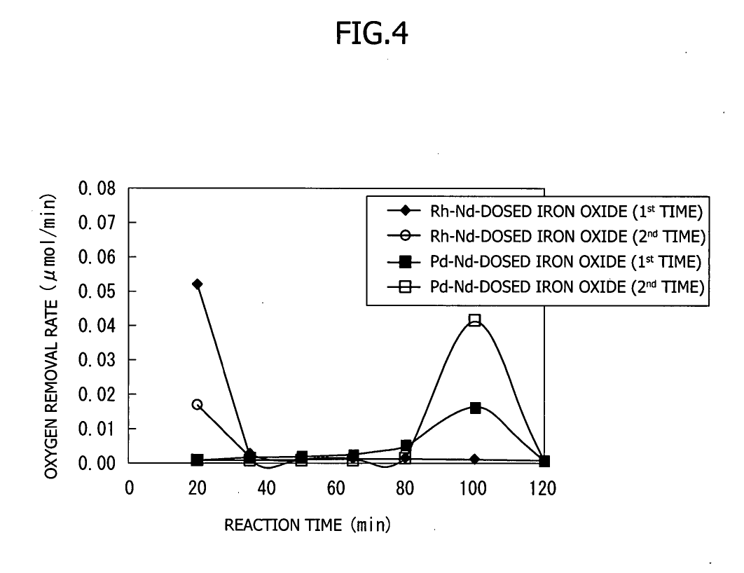

Except for a chloride of palladium (PdCl₂) (manufactured by Wako Pure Chemical Industries Ltd) being dosed instead of the chloride of rhodium (RhCl₃.3H₂O), a Pd—Nd-dosed iron oxide was prepared by the same procedure as in Working Example 2, and the experiment of the reduction reaction and the water-decomposing reaction was performed. The results of Working Examples 2 and 3 are shown in FIG. 4, FIG. 7 and FIG. 8.

### WORKING EXAMPLES 4 to 9

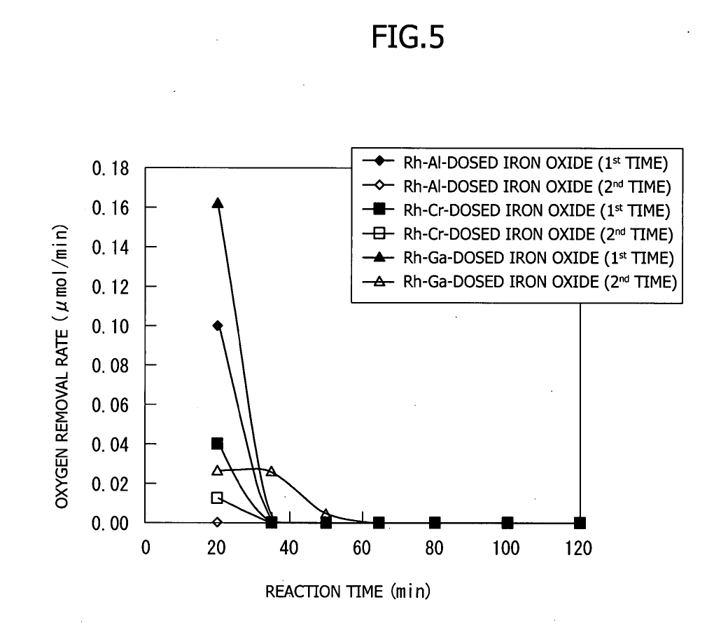

Except for a nitrate of aluminum (Al (NO₃)₃).9H₂O) (manufactured by Wako Pure Chemical Industries Ltd), a nitrate of chromium (Cr(NO₃)₃.9H₂O) (manufactured by Wako Pure Chemical Industries Ltd), a nitrate of gallium (Ga(NO₃)₃.nH₂O (n=7 to 9)) (manufactured by Wako Pure Chemical Industries Ltd), a nitrate of yttrium (Y(NO₃)₃.6H₂O) (manufactured by Soekawa Chemical Co. Ltd.), a chloride of zirconium (ZrCl₂O.8H₂O) (manufactured by Kanto Kagaku) and an ammonium salt of molybdenum ((NH₄)₆Mo₇O₂₄.4H₂O) (manufactured by Wako Pure Chemical Industries Ltd) being dosed instead of the nitrate of neodymium (Nd(NO₃)₃.6H₂O), an Rh—Al-dosed, an Rh—Cr-dosed, an Rh—Ga-dosed, an Rh—Y-dosed, an Rh—Zr-dosed and an Rh—Mo-dosed iron oxide were prepared by the same procedure as in Working Example 2, and the experiment of the reduction reaction and the water-decomposing reaction was performed. The results of Working Examples 4 to 9 are shown in FIG. 5 to FIG. 8.

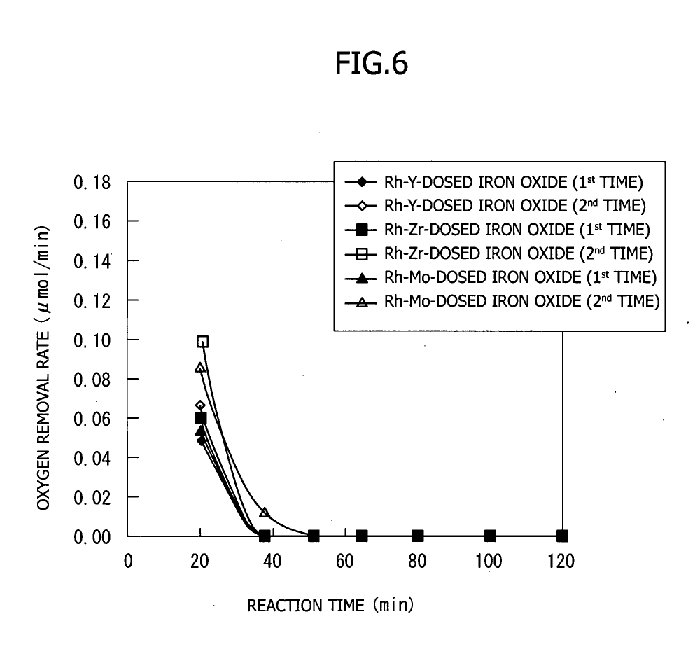

As shown in FIG. 3, it can be seen that the additive-free iron oxide produced substantially no CO and CO₂ through the 100 minutes of the reduction reaction, and the reduction did not proceed. On the other hand, it can be seen that although the reduction dropped a bit during the second time, the reduction of the Rh-dosed iron oxide proceeded. Furthermore, the reduction of the Nd-dosed iron oxide did not proceed as with the case of the additive free iron oxide. However, as shown in FIG. 4, it can be seen that with the addition of Rh and Pd, which are platinum group elements, the reduction proceeded, as with the Rh—Nd-dosed iron oxide, and the Pd—Nd-dosed iron oxide. Particularly, for the Rh—Al-dosed iron oxide and the Rh—Ga-dosed iron oxide, the amount reduced was much greater than that of the Rh-dosed iron oxide, as shown in FIG. 5. As shown in FIG. 6, it can be seen that for the Rh—Y-dosed iron oxide, the Rh—Zr-dosed iron oxide and the Rh—Mo-dosed iron oxide, the reduction advanced further during the second time than the first.

As shown in FIG. 7, the amount of hydrogen generated by the additive-free iron oxide and the Nd-dosed iron oxide, which are the comparative examples, is very small, and there was substantially no hydrogen generation even when the temperature was raised to 500° C. On the other hand, the iron oxides to which platinum group elements were dosed, which are the working examples, generated hydrogen at least 0.02 mol H₂/mol Fe at 400° C., and were able to generate hydrogen at least 0.07 mol H₂/mol Fe when the temperature was raised to 500° C. In particular, the amount of hydrogen generated by the Rh—Ga-dosed iron oxide and the Pd—Nd-dosed iron oxide was very high at least 0.10 mol H₂/mol Fe.

It should be noted that, as shown in FIG. 8, the Rh—Al-dosed iron oxide, the Rh—Cr-dosed iron oxide, the Rh—Mo-dosed iron oxide and the Pd—Nd-dosed iron oxide produced CO and CO₂ as well as hydrogen during the first reaction. However, it can be seen that substantially no CO and CO₂ were generated during the reaction the second time. That is to say, it can be seen that with iron oxide to which platinum group elements have been dosed, it is possible to obtain hydrogen that contains substantially no CO and CO₂.

### WORKING EXAMPLE 10

Iron oxide into which copper is dosed was prepared by the co-precipitation method (urea method) shown below. Firstly, 0.018 mol of iron (III) nitrate nonahydrate (Fe(NO₃)₃.9H₂O) (manufactured by Wako Pure Chemical Industries Ltd), 0.001 mol of a chloride of copper (Cu(NO₃)₂.3H₂O) (manufactured by Wako Pure Chemical Industries Ltd), 0.001 mol of a nitrate of chromium (Cr(NO₃)₃.9H₂O) (manufactured by Wako Pure Chemical Industries Ltd) and 1.0 mol of urea as a precipitating agent, were added into 1 L of water that had been deaerated with ultrasound for 5 min, and dissolved. The mixed solution was heated to 90° C. while agitating, and held at the same temperature for 3 hours. After reacting, the solution was left to settle for 48 hours and was then suction filtered. The obtained precipitate was then dried for 24 hours at 80° C., then for 3 hours at 300° C., and was then burnt in air for 10 hours at 500° C. 0.222 g of the Cu—Cr-dosed iron oxide obtained in this way was weighed out, that is to say, the Cu—Cr-dosed iron oxide was weighed out so as to include 0.2 g of Fe₂O₃ (ferric oxide) when the copper ions and the chromium ions were each taken to be 5 mol % of the total metal ions, and the compounds were taken to be Fe₂O₃, CuO and Cr₂O₃. This resulting material was used as the sample in the experiment described below.

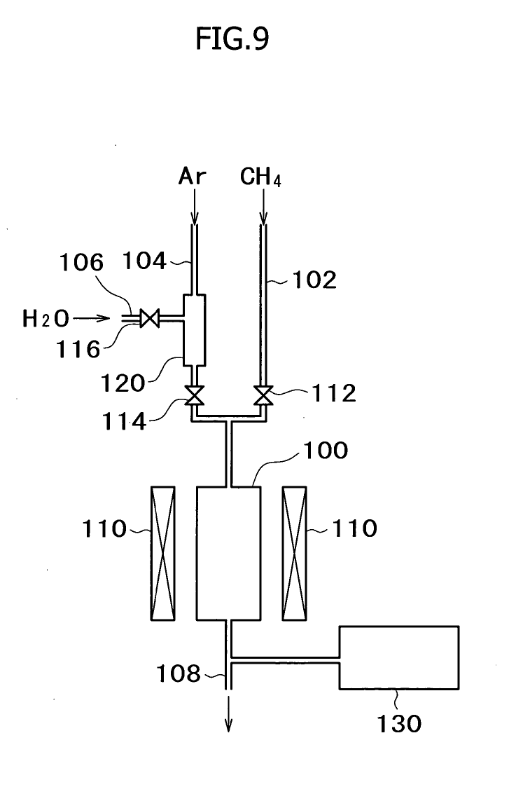

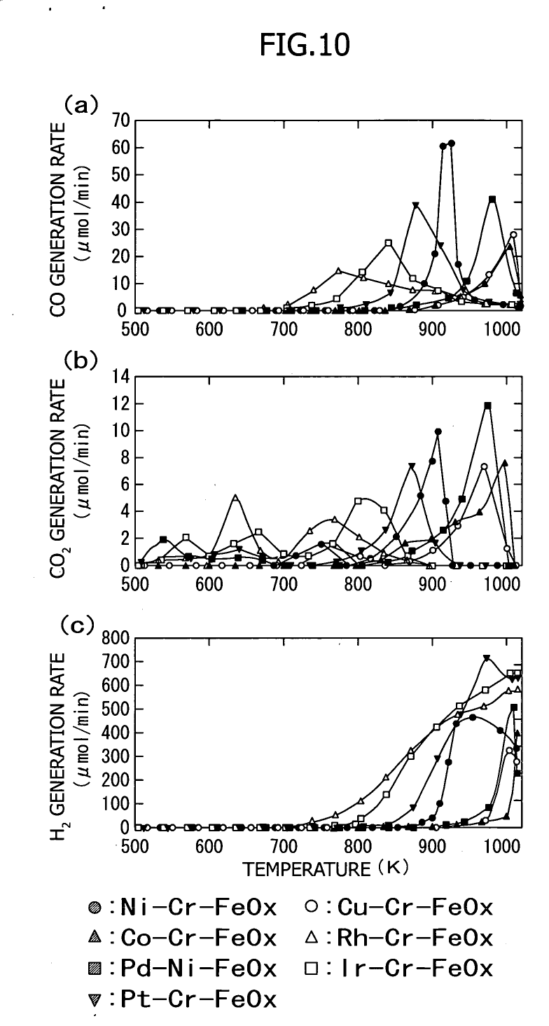

Next, after reduction of the obtained Cu—Cr-dosed iron oxide by methane, using the apparatus shown below, an experiment was performed to generate hydrogen by contact with water vapor. FIG. 9 is a view schematically showing an overview of a normal pressure fixed-bed flow-type reaction apparatus used in the present experiment. As shown in FIG. 9, firstly, the sample of obtained Cu—Cr-dosed iron oxide was placed in a reaction vessel 100, valves 112 and 116 opened, and a valve 114 closed, after which argon, which is an inert gas, was allowed to flow from a tube 104 to purge air from the system. After this, the valve 112 was opened and the valve 114 closed, and methane was introduced from the tube 102 into the reaction vessel 100. The temperature of the reaction vessel 100 was then raised from 200° C. to 750° C. by electric furnaces 110 provided on the reaction vessel 100 at an increase of 3° C. per minute, to carry out the reduction reaction. The gas generated by the reduction reaction was discharged from a tube 108, and some of the gas was sampled and measured by a gas chromatograph 130. Based on these results, the number of moles of CO, CO₂ and H₂ generated per minute was calculated (generating rate, units: μmol/min). The results are shown in FIG. 10.

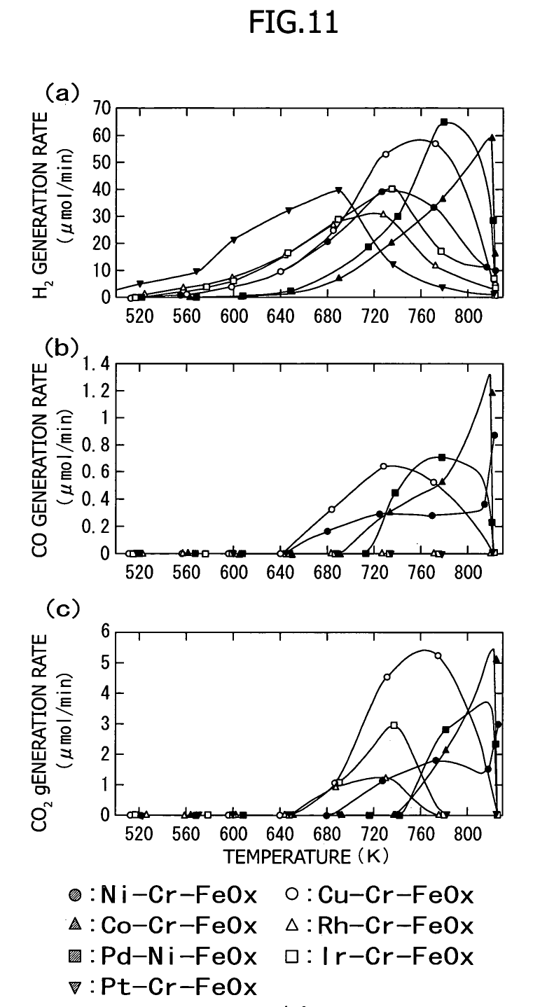

After completing the reduction reaction with methane, the valve 112 was closed and a valve 104 opened to allow argon into the system from the tube 104, and to remove the carbon monoxide, carbon dioxide and water vapor from the system. After this, the valve 116 was opened, water was allowed from a pipe 106 into a vaporizer 120 where it was vaporized, and using argon as a carrier gas, the water was allowed into the reaction vessel 100 where the water-decomposing reaction was performed. At this time, the temperature of the reaction vessel 100 was raised from 200° C. to 550° C. by the electric furnaces 110, at an increase of 4° C. per minute. In the same manner as the reduction reaction, the produced gas was measured using the gas chromatograph 130, and the generating rate of CO, CO₂ and H₂ was calculated. The results are shown in FIG. 11.

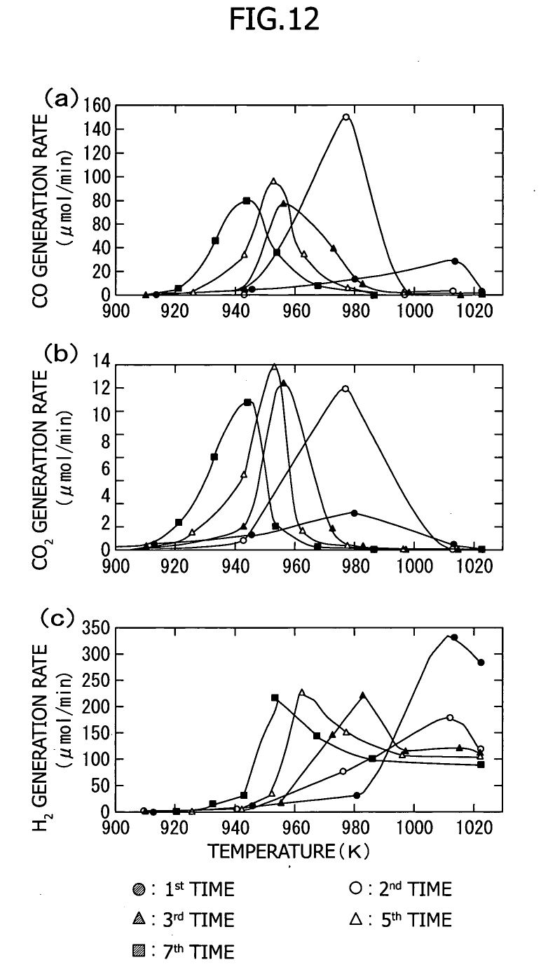

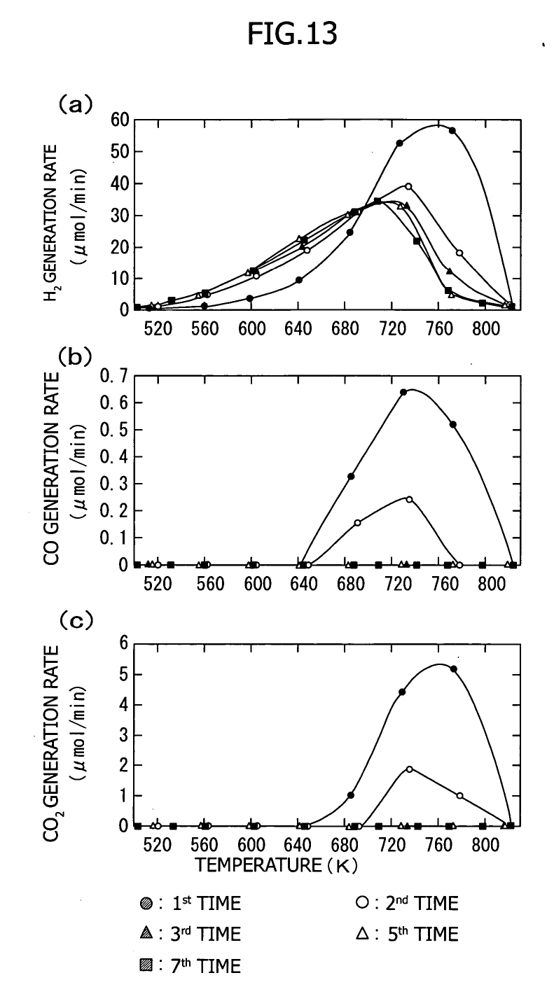

Moreover after the water-decomposing reaction was completed, the reduction reaction and the water-decomposing reaction were performed again by the same procedures as are described above, and the reduction reaction and the water-decomposing reaction were repeated for a total of seven times each. The results of the seven reduction reactions are shown in FIG. 12, and the results of the seven water-decomposing reactions are shown in FIG. 13.

### WORKING EXAMPLES 11 to 16

Except for a nitrate of nickel (Ni (NO₃)₂).6H₂O) (manufactured by Wako Pure Chemical Industries Ltd), a nitrate of cobalt (Co(NO₃)₂.6H₂O) (manufactured by Wako Pure Chemical Industries Ltd), a chloride of rhodium (RhCl₃.3H₂O) (manufactured by Wako Pure Chemical Industries Ltd), a chloride of Iridium (IrCl₃.nH₂O) (manufactured by Soekawa Chemical Co. Ltd.) and chloroplatinic acid (H₂PtCl₆) (manufactured by Wako Pure Chemical Industries Ltd) being dosed instead of the nitrate of copper (Cu(NO₃)₂.3H₂O), an Ni—Cr-dosed, a Co—Cr-dosed, an Rh—Cr-dosed, an Ir—Cr-dosed and a Pt—Cr-dosed iron oxide was prepared by the same procedure as in Working Example 10, and the experiment of the reduction reaction and the water-decomposing reaction was performed. Furthermore, apart from the fact that a chloride of palladium (PdCl₂) (manufactured by Wako Pure Chemical Industries Ltd), and a nitrate of nickel (Ni(NO₃)₂.6H₂O were dosed instead of the nitrate of copper (Cu(NO₃)₂.3H₂O) and the nitrate of chromium (Cr(NO₃)₃.9H₂O), a Pd—Ni-dosed iron oxide was prepared by the same procedure as in Working Example 10, and the experiment of the reduction reaction and the water-decomposing reaction was performed. The results of Working Examples 11 to 16 are shown in FIG. 10 and FIG. 11.

As shown in FIG. 10a and FIG. 10b, the Cu—Cr-dosed, Ni—Cr-dosed and Co—Cr-dosed iron oxides showed a substantially similar CO and CO₂ generating rate as that of the Rh—Cr-dosed, Pd—Ni-dosed, Ir—Cr dosed and Pt—Cr-dosed iron oxides. Thus, even if Cu, Ni and Co are substituted for platinum group elements, it is possible to confirm that the reduction reaction will proceed. It should be noted that, as shown in FIG. 10c, hydrogen was also generated in the reduction reaction, and this hydrogen generation is a result of a side reaction in which methane is broken down directly into hydrogen during reduction. Furthermore, water generated during reduction was not measured, but in any reaction where water generation is proportional to the amount of carbon monoxide and carbon dioxide, the amount can be analyzed qualitatively.

Furthermore, as shown in FIG. 11a, the Cu—Cr-dosed, Ni—Cr-dosed and Co—Cr-dosed iron oxides showed a hydrogen generating rate that was substantially the same as that of the Rh—Cr-dosed, Pd—Ni-dosed, Ir—Cr-dosed and Pt—Cr-dosed iron oxides, which have been dosed with platinum group elements. Thus, it can be confirmed that even if Cu, Ni or Co is dosed instead of the platinum group elements, hydrogen will be generated.

Moreover, as shown in FIG. 12a and FIG. 12b, and FIG. 13a, for the Cu—Cr-dosed iron oxide, the reduction proceeded and hydrogen was generated even if the reduction reaction and the water-decomposing reaction were repeated seven times. Furthermore, as shown in FIG. 13b and FIG. 13c, CO and CO₂ were produced as by-products until the second water-decomposing reaction, but in the third and subsequent water-decomposing reactions, the side production of CO and CO₂ was substantially zero, and only pure hydrogen was produced.

### INDUSTRIAL APPLICABILITY

Since the method for reducing metal oxides and the hydrogen manufacturing method of the present invention can easily reduce an oxide of a metal for decomposing water and for generating hydrogen, by a gas that includes hydrocarbons, such as municipal gas, the present invention may be utilized in hydrogen manufacturing apparatuses or fuel cells.

1. A method for reducing a metal oxide, comprising:
a step of reducing, using a reducing gas that includes hydrocarbons, a medium comprising an oxide of a metal for decomposing water to generate hydrogen, and at least one metal selected from the group consisting of platinum group elements, copper, nickel and cobalt.

2. The method for reducing a metal oxide according to claim 1,
wherein the metal for decomposing water to generate hydrogen is at least one metal selected from the group consisting of iron, indium, tin, magnesium, gallium, germanium and cerium.

3. The method for reducing a metal oxide according to claim 1,
wherein the medium further comprises at least one metal selected from the group consisting of neodymium, aluminum, chromium, gallium, yttrium, zirconium, molybdenum, titanium, vanadium, magnesium and scandium.

4. The method for reducing a metal oxide according to claim 1,
wherein an exhaust gas generated in the reduction step is used again as a reducing gas.

5. The method for reducing a metal oxide according to claim 1,
wherein an exhaust gas generated in the reduction step is used as fuel for heating the medium.

6. A method for manufacturing hydrogen, comprising:
the reduction step according to claim 1, and
a water-decomposing step of reacting water with the medium that is reduced in the reduction step, thereby generating hydrogen.

7. The method for manufacturing hydrogen according to claim 6,
wherein hydrogen is continuously manufactured by using at least two media, in which one medium is used for reducing in the reduction step while the other medium is used for generating hydrogen in the water-decomposing step.

8. The method for manufacturing hydrogen according to claim 6, further comprising:
a medium washing step of supplying oxygen to the medium to burn off carbon that is deposited on the medium.

9. The method for reducing a metal oxide according to claim 2,
wherein the medium further comprises at least one metal selected from the group consisting of neodymium, aluminum, chromium, gallium, yttrium, zirconium, molybdenum, titanium, vanadium, magnesium and scandium.

10. The method for reducing a metal oxide according to claim 2,
wherein an exhaust gas generated in the reduction step is used again as a reducing gas.

11. The method for reducing a metal oxide according to claim 3,
wherein an exhaust gas generated in the reduction step is used again as a reducing gas.

12. The method for reducing a metal oxide according to claim 9,
wherein an exhaust gas generated in the reduction step is used again as a reducing gas.

13. The method for reducing a metal oxide according to claim 2,
wherein an exhaust gas generated in the reduction step is used as fuel for heating the medium.

14. The method for reducing a metal oxide according to claim 3,
wherein an exhaust gas generated in the reduction step is used as fuel for heating the medium.

15. The method for reducing a metal oxide according to claim 4,
wherein an exhaust gas generated in the reduction step is used as fuel for heating the medium.

16. A method for manufacturing hydrogen, comprising:
the reduction step according to claim 2, and
a water-decomposing step of reacting water with the medium that is reduced in the reduction step, thereby generating hydrogen.

17. A method for manufacturing hydrogen, comprising:
the reduction step according to claim 3, and
a water-decomposing step of reacting water with the medium that is reduced in the reduction step, thereby generating hydrogen.

18. A method for manufacturing hydrogen, comprising:
the reduction step according to claim 4, and
a water-decomposing step of reacting water with the medium that is reduced in the reduction step, thereby generating hydrogen.

19. A method for manufacturing hydrogen, comprising:
the reduction step according to claim 5, and
a water-decomposing step of reacting water with the medium that is reduced in the reduction step, thereby generating hydrogen.

20. The method for manufacturing hydrogen according to claim 7, further comprising:
a medium washing step of supplying oxygen to the medium to burn off carbon that is deposited on the medium.
